(19) United States
(12) Patent Application Publication
(10) Pub. No.: US 2004/0258132 A1
(43) Pub. Date: Dec. 23, 2004

(54) Apparatus for generating an additive white Gaussian noise

(75) Inventor: Dong Ho Hong, Seoul (KR)

Correspondence Address: McGuireWoods, Suite 1800, 1750 Tysons Boulevard, McLean, VA, 22102-4215, US

(73) Assignee: Willtek Corporation

(21) Appl. No.: 10/464,765

(22) Filed: Jun. 19, 2003

(51) Int. Cl. H04K 1/00

(52) U.S. Cl. 375/130

(57) ABSTRACT

An additive white Gaussian noise (AWGN) generator for use in a communications system includes a microprocessor for determining a coefficient by multiplying a signal to noise ratio (SNR) with a value of a Gaussian density function, a memory device for storing the coefficient, a random number generator for generating N-bit address which is used to access a coefficient stored in the memory device, an adder for adding the coefficient accessed from the memory device by using the N-bit address to an input signal in a digital domain, and a digital/analog converter for converting a digital output of the adder into an analog signal. The AWGN generator shows flat frequency response at a slow symbol rate, e.g., a symbol rate of an input channel signal and, therefore, the channel signal and the AWGN signal may be added easily in the digital domain.

### FIELD OF THE INVENTION

The present invention relates to an apparatus for generating an additive white Gaussian noise (AWGN); and, more particularly, to an apparatus for generating an additive white Gaussian noise in a base band in a digital domain to add the generated noise to an input signal also in the digital domain.

### BACKGROUND OF THE INVENTION

As well known in the art, various kinds of waves, such as a sine wave having a certain frequency, a white noise and a pink noise in various frequencies bandwidths, are used for experiments of analog or digital communications systems. A conventional white noise generator generates a white noise in an analog domain and also adds the generated white noise to a channel signal in the analog domain for experiments. However, manipulating signals in the analog domain causes an error between in-phase (I) and quadrature-phase (Q) channels and makes adjustment in a signal to noise ratio (SNR) more difficult.

Meanwhile, if an AWGN signal is generated and the generated signal is added to a channel signal in a digital domain, an error between I and Q channels will be reduced and an SNR can be easily adjusted. In such an AWGN generator, values of Gaussian probability density function are stored in a memory and the values thereof are selected by using random numbers uniformly generated at a random number generator, the selected values being white noises. In this case, a statistic characteristic of the white noise depends on the values of Gaussian probability density function and the random number that is uniformly generated and is used to select the values. Further, a frequency characteristic of the white noise, which should be flat over an entire bandwidth, mainly depends on the random number uniformly generated.

Moreover, the characteristic of the white noise requires flatness over a broader bandwidth than that of a channel signal in a band-limited channel. If the random number used for selecting the values of Gaussian probability density function is designed improperly, a symbol rate of the generated white noise should be several times as fast as that of the channel signal in order to accomplish flatness of the power spectral density of the white noise, which results in higher hardware complexity and high cost in implementing a digital communications system. And also, if the symbol rate of the white noise is too fast, a modulation of the channel signal and the white noise becomes hard to implement in the digital domain due to a hardware limitation and even if modulation is implemented in the digital domain, an expensive digital/analog converter operable at high speed is required.

### SUMMARY OF THE INVENTION

It is, therefore, an object of the present invention to provide an additive white Gaussian noise (AWGN) generator for generating an AWGN in a digital domain, wherein the user can adjust a signal to noise ratio (SNR) easily and a frequency characteristic of the generated white noise is flat at an equal symbol rate as that of the channel signal.

In accordance with a preferred embodiment of the present invention, there is provided an additive white Gaussian noise generator for use in a communications system, comprising: a microprocessor for determining a coefficient by multiplying a certain signal to noise ratio (SNR) with a value of a Gaussian density function and outputting the coefficient; a memory device for storing coefficients; a random number generator for generating an N-bit address which is used to access a coefficient stored in the memory device, wherein N is an integer larger than 1; an adder for adding the coefficient accessed from the memory device by using the N-bit address to an input channel signal in a digital domain; and a digital/analog converter for converting a digital output of the adder into an analog signal.

### BRIEF DESCRIPTION OF THE DRAWINGS

The above and other objects and features of the present invention will become apparent from the following description of a preferred embodiment given in conjunction with the accompanying drawings, in which:

FIG. 1 illustrates a block diagram of an AWGN generator in accordance with the present invention;

FIG. 2 sets forth a detailed block diagram of a random number generator shown in FIG. 1;

FIG. 3 shows a flat frequency characteristic of a conventional single random number generator; and

FIG. 4 describes a flat frequency characteristic of the random number generator in accordance with the present invention.

### DETAILED DESCRIPTION OF THE PREFERRED EMBODIMENTS

A preferred embodiment of the present invention will now be described in detail with reference to the accompanying drawings.

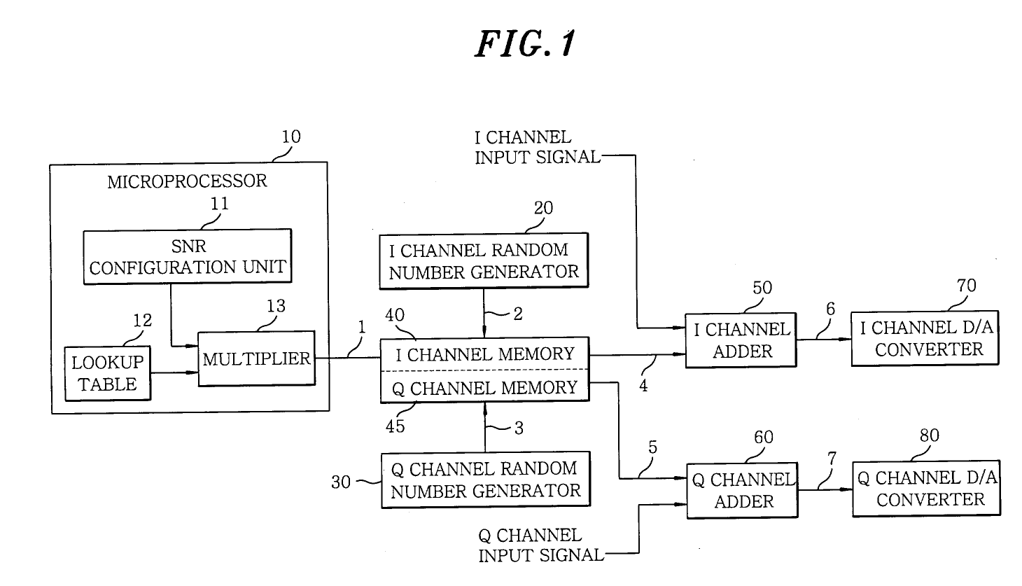

As described in FIG. 1, an additive white Gaussian noise (AWGN) generator in accordance with the present invention includes a microprocessor 10, an in-phase (I) channel random number generator 20, a quadrature-phase (Q) channel random number generator 30, an I channel memory 40, a Q channel memory 45, an I channel adder 50, a Q channel adder 60, an I channel digital/analog (D/A) converter 70 and a Q channel D/A converter 80. Further, the microprocessor 10 has a signal to noise ratio (SNR) configuration unit 11, a lookup table 12 and a multiplier 13.

The SNR configuration unit 11 determines SNR in accordance with user's selection based on the I/Q channel signal SNR and, in accordance with the selected SNR, a value of a lookup table 12 which is Gaussian distributed is multiplied with the selected SNR to output a coefficient of white Gaussian noise. The coefficient is then stored in the I channel memory 40 or the Q channel memory 45.

Meanwhile, the I channel random number generator 20 generates N-bit I channel address 2 and transmitting the generated address to the I channel memory 40. Further, the Q channel random number generator 30 generates N-bit Q channel address 3 and transmitting the generated address to the Q channel memory 45.

A coefficient stored in the I channel memory 40 is accessed by using the I channel address 2 generated by the I channel random number generator 20 and is transferred to the I channel adder 50 as an I channel AWGN signal 4. Also, a coefficient stored in the Q channel memory 45 is accessed by using the Q channel address 3 generated by the Q channel random number generator 30 and is transferred to the Q channel adder 60 as a Q channel AWGN signal 5.

Further, the I channel AWGN signal 4 is added to an I channel input signal in the I channel adder 50. The addition of the signals is performed at an identical symbol rate in the digital domain and the added signal 6 is transmitted to the I channel D/A converter 70. Also, at the Q channel adder 60, the Q channel AWGN signal 5 is added to Q channel input signal at an identical symbol rate in the digital domain, and the added signal 7 is transmitted to the Q channel D/A converter 80. The I channel D/A converter 70 converts the I channel signal 6 into an analog signal. The Q channel D/A converter 80 converts the Q channel signal 7 into an analog signal.

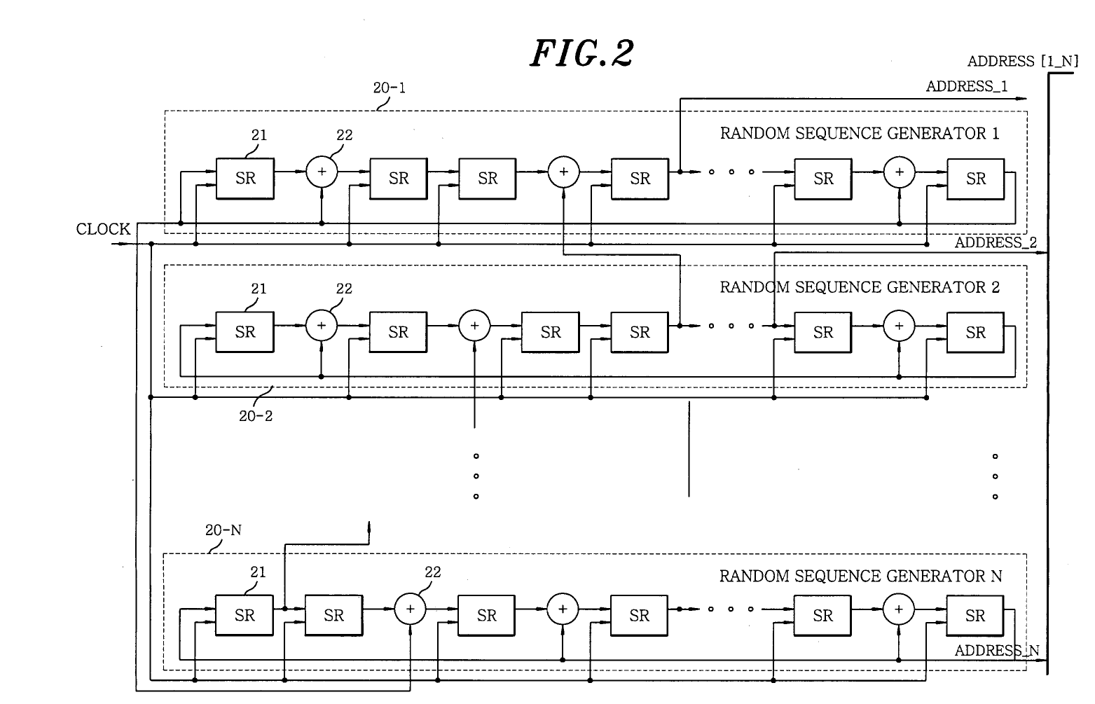

FIG. 2 is a detailed block diagram of a random number generator, i.e., the I channel random number generator 20 shown in FIG. 1 in accordance with the present invention. The Q channel random number generator 30 has a same structure as the I channel random number generator 20, and therefore the detailed structure of the Q channel random number generator 30 will not be shown separately.

The I channel random number generator 20 includes N number of random sequence generators 20-1 to 20-N which are interconnected to each other. The number of N random sequence generators corresponds to the number of bits of the address for accessing coefficients stored in the I channel memory 40. That is, one random sequence generator corresponds to one bit of the address. Each of the random sequence generators 20-1 to 20-N has M number of shift registers (SRs) 21 and K number of adders 22, wherein both M and K are positive integers, K being not greater than M. Further, M and K may vary depending on each of the random sequence generators. Herein, each of the SRs may be initialized by using random binary number under a condition that not all initial values of the SRs are 0. Accordingly, a degree of randomness of the address generated from the random sequence generators has no relation with polynomials represented by interconnections thereof. The polynomials represent logic equations made by the interconnections between the adders and the SRs in the random sequence generators 20-1 to 20-N. Further, the interconnections of the random sequence generators 20-1 to 20-N, i.e., the interconnections between the SRs 21 and adder 22, are made such that one of outputs of the SRs 21 of a random sequence generator is connected to a certain adder of another random sequence generator and one of outputs of the SRs is provided as one bit of the N-bit address to be used for selecting the coefficients from the I channel memory 40.

The statistical characteristic of an AWGN signal to be added with a channel signal depends on the values of the lookup table 12 and the degree of randomness of the random number generators 20 and 30. Further, the flatness of frequency distribution of the AWGN signal depends on the random number generators 20 and 30.

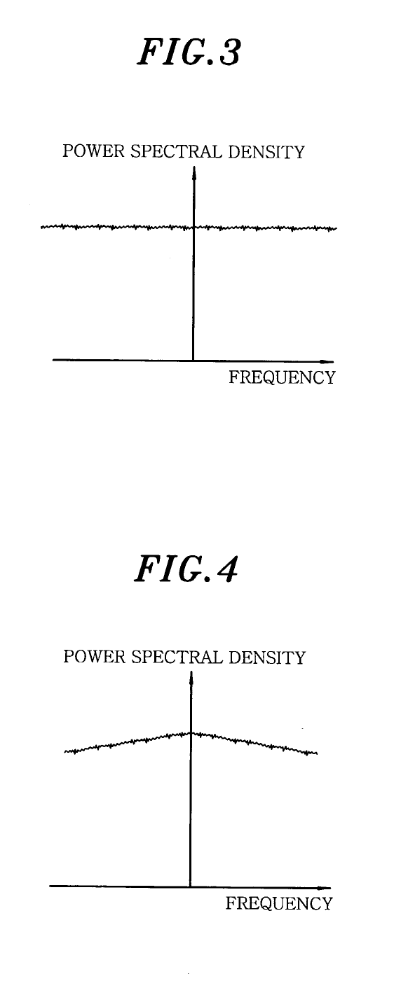

FIG. 3 shows a frequency characteristic of an output response of a communications system where a conventional single random number generator is used, and FIG. 4 describes a frequency characteristic of an output response of a communications system where the random number generator in accordance with the present invention is used for generating AWGN signal.

Referring to FIGS. 3 and 4, on the condition that the symbol rate of the AWGN signal is equal to that of the channel signal, the AWGN signal generated by the AWGN generator in accordance with the present invention has more flat response characteristic than that of the conventional noise generator. If the output response of the conventional noise generator is required to have same flatness with that of the AWGN generator of the present invention, a symbol rate of the AWGN signal should be several times as fast as that of the channel signal.

As described above, the AWGN generator in accordance with the present invention generates a white noise having a flat frequency response even at a slow symbol rate, e.g., a symbol rate of a channel signal, so that the generated white noise and the channel signal may be added easily in the digital domain. Therefore, the AWGN generator in accordance the present invention reduces error between the I channel and the Q channel and is cost effective.

While the invention has been shown and described with respect to the preferred embodiment, it will be understood by those skilled in the art that various changes and modifications may be made without departing from the spirit and scope of the invention as defined in the following claims.

What is claimed is:

1. An additive white Gaussian noise (AWGN) generator for use in a communications system, comprising:
a microprocessor for determining a coefficient by multiplying a certain signal to noise ratio (SNR) with a value of a Gaussian density function and outputting the coefficient;
a memory device for storing the coefficient;
a random number generator for generating an N-bit address which is used to access a coefficient stored in the memory device, wherein N is an integer larger than 1;
an adder for adding the coefficient accessed from the memory device by using the N-bit address to an input channel signal in a digital domain; and
a digital/analog converter for converting a digital output of the adder into an analog signal.

2. The generator of claim 1, wherein the microprocessor comprises
an SNR configuration unit for adjusting the SNR;
a lookup table for storing values of the Gaussian density function;
a multiplier for multiplying the SNR with a value of the lookup table to determine the coefficient.

3. The generator of claim 1, wherein the random number generator includes N random sequence generators, each of which generates a corresponding bit of the N-bit address to be used in accessing a coefficient stored in the memory device and is interconnected to each other arbitrarily.

4. The generator of claim 3, wherein iₜₕ random sequence generator of the N random sequence generators has Mᵢ number of shift registers (SRs) and Kᵢ number of adders connected to form a feedback circuit, Mᵢ and Kᵢ being positive integer and Kᵢ being not greater than Mᵢ, and an output of a first SR included in the iₜₕ random sequence generator is coupled to a certain adder included in a jₜₕ random sequence generator and an output of a second SR of the iₜₕ random sequence generator is provided as iₜₕ bit of the N-bit address, wherein i and j are positive integers not greater than N and i is not equal with j.
